(19) United States
(12) Patent Application Publication
(10) Pub. No.: US 2024/0370734 A1
(43) Pub. Date: Nov. 7, 2024

(54) Generative Future Predictions based on Complex Events

(71) Applicant: Microsoft Technology Licensing, LLC, Redmond, WA (US)

(72) Inventors: Peeyush KUMAR, Seattle, WA (US); Boling YANG, Seattle, WA (US); Riyaz PISHORI, Sammammish, WA (US); Ranveer CHANDRA, Kirkland, WA (US)

(73) Assignee: Microsoft Technology Licensing, LLC, Redmond, WA (US)

(21) Appl. No.: 18/142,898

(22) Filed: May 3, 2023

(51) Int. Cl. G06N 3/092

(52) U.S. Cl. CPC G06N 3/092

(57) ABSTRACT

This document relates to accurate quantitative predictions relating to various systems of interest. One example can obtain temporal data relating to a system from a first source and obtain complex events that can affect the system from a second source. The example can train a model iteratively using generative networks that correlate the temporal data from the first source and the complex events from the second source. The example can employ a temporal sequential encoder to control predictions for future temporal data utilizing the trained model.

### BACKGROUND

Large language models are trained with large amounts of training data and are proficient at providing highly accurate qualitative responses to queries that are similar to the training data. However, large language models are not proficient at making quantitative predictions.

### SUMMARY

This document relates to accurate quantitative predictions relating to various systems of interest. One example can obtain temporal data relating to a system from a first source and obtain complex events that can affect the system from a second source. The example can train a model iteratively using generative networks that correlate the temporal data from the first source and the complex events from the second source. The example can employ a temporal sequential encoder to control predictions for future temporal data utilizing the trained model.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1A and 1B show an example dashboard that is consistent with some implementations of the present concepts.

FIGS. 2, 5, 6, and 13 illustrate example systems that are consistent with some implementations of the present concepts.

FIGS. 3, 4, and 7 illustrate example frameworks that are consistent with some implementations of the present concepts.

FIGS. 8-10 illustrate example graph results that are consistent with some implementations of the present concepts.

FIGS. 11 and 12 illustrate example flowcharts that are consistent with some implementations of the present concepts.

### DETAILED DESCRIPTION

### Overview

The present concepts offer computational frameworks or systems that monitor events happening across the world and generate quantitative predictions for possible changes to systems being studied (e.g., system of interest). The changes can be caused by a few relatively rare complex events.

The computational system uses large language models to encode knowledge that pertains to the system of interest. Rare complex events (or ‘events’) relating to the system of interest can also be obtained. Given a set of events, the large language models provide further information on how these events could be related to the studied system (e.g., which events cause what changes to the system). The computational system then quantitatively predicts the possible future outcomes of one or more aspects of the studied system. The present concepts provide quantitative modeling and predictions based on both historical system data and events relating to the data.

Existing prediction solutions include time-series forecasting, which has been an active research area since the 20th century. More recent existing research has been trying to augment expert knowledge to improve the prediction quality. Existing Bayesian structural time-series models use a Bayesian framework to incorporate expert knowledge into the forecasting process by specifying prior beliefs about the underlying structure of the time-series data.

Existing causal inference methods use expert knowledge to identify relevant causal relationships in a causal graph. Fuzzy logic is a simple method that has also been used to represent uncertainty and imprecision in the data and expert knowledge with good readability and scalability. Carefully selected loss functions can use expert features to learn better representation of the data. For example, the pair-loss functions in contrastive learning are widely used in the vision domain, and there are more recent works that experiment with contrastive learning approaches with time-series related training. Deep metric learning and knowledge distillation is another alternative approach to make use of the continuous nature of the expert features. To incorporate expert knowledge with neural network training, existing works typically use an embedding for input trajectories for improved labeling-efficiency. None of these existing solutions can provide quantitative predictions about the system of interest using historical data and relatively rare complex events relating to the system.

In this description, systems of interest can entail many different types of applications. For example, one system of interest may entail salmon returns to a watershed. Data values for such a system may relate to historic numbers of salmon returning to the watershed. Rare or complex events, such as droughts, ocean conditions, and/or habitat degradation may have affected the salmon returns over time. The present concepts can find the correlation between past complex events and past returns. The present concepts can then use these correlations to make predictions about future salmon returns based upon these and/or other complex events. For instance, the present concepts can generate salmon return predictions for the watershed if a dam is proposed on a portion of the watershed or if a dam removal is proposed, for example. Thus, the present concepts entail a technical solution that provides quantitative predictions of future system values (e.g., returning salmon numbers). These predictions can allow interested parties, such as fisheries managers, utilities, policy makers, etc. to make informed decisions to reduce/avoid undesirable outcomes, such as reduced fish stocks and/or extinction.

Other applications (e.g., systems of interest) can involve health care scenarios. For instance, system data could track a person's blood glucose levels. Various rare events could be correlated to changes in the blood glucose levels. The present concepts provide the technical solution of quantitative predictions that could be made for current or future events so that actions can be taken to avoid high or low glucose levels and enhance patient health.

In the description below, the present concepts are explained in relation to applications involving the food supply chain systems for purposes of explanation. As mentioned above, the present concepts are equally applicable to other studied systems. The quantitative predictions provided by the present concepts can enhance food security through informed decision making based upon the quantitative food supply chain predictions. This provides a technical solution that allows food producers to make informed decisions, such as which crops to plant and how much of each crop to plant. The actions based on informed decisions can avoid/reduce food shortages and associated human suffering.

The proper functioning of the global food supply chain is very important as it helps to ensure that people around the world have access to the food they need to survive. The global food supply chain is a complex system that involves the production, processing, distribution, and storage of food. Furthermore, agriculture and food trading make up a large portion of many countries' GDP, making the food supply chain a major contributor to the global economy. However, the global food supply chain system is extremely fragile to unexpected events that disturb the normal functioning of one or multiple entities of the system.

These events are typically large and rare local or global events such as war, natural disasters, and so on. For example, the war between Russia and Ukraine has resulted in a massive decline in the supply of major staple foods and has led to a rise in food prices globally. The developing and emerging economies are the biggest victims due to their reliance on the region for fuel and grain imports. The food expenses in many developing nations have risen to half of the total cost of living. Other than the developing countries, the rest of the world is now also suffering from rapidly rising food prices. The quantitative predictions provided by the present concepts could have allowed food producers (e.g., farmers) to have better and earlier predictions that could have allowed them to increase plantings of the affected crops and thus reduce the shortfall and associated hunger.

Modeling how unexpected, rare events influence the supply chain system can be very challenging. There are many factors that could impact the system, and impacts can be directly or implicitly related to global or local events. One event or the combination of multiple events could cause subsequent problems that worsen the existing situations. For example, Russia and China exported 28% of the world's fertilizers in the terms of trade value. The 2019 pandemic in China and the 2020 Russian invasion of Ukraine resulted in drastic increases in the price of fertilizers, which has farmers worldwide reducing planned harvests and the amount of land they're planting. This led to increased food prices in a list of key food producing countries, and these countries are limiting exports to stabilize their own markets.

In relation to the food supply chain system, the present computational system monitors events happening across the world and predicts the possible changes to the food supply chain system. The computational system uses large language models to encode knowledge that is related to agriculture, food manufacturing, etc. Given a set of events, the language models provide further information on how these events could be related to the food supply chain. The system then predicts the possible future outcomes of one or more aspects of the supply chain, such as crop harvest, food commodity stocks, and food prices. The description below explains examples for how to model and predict food supply chain system changes given events information.

### Use Case Scenario

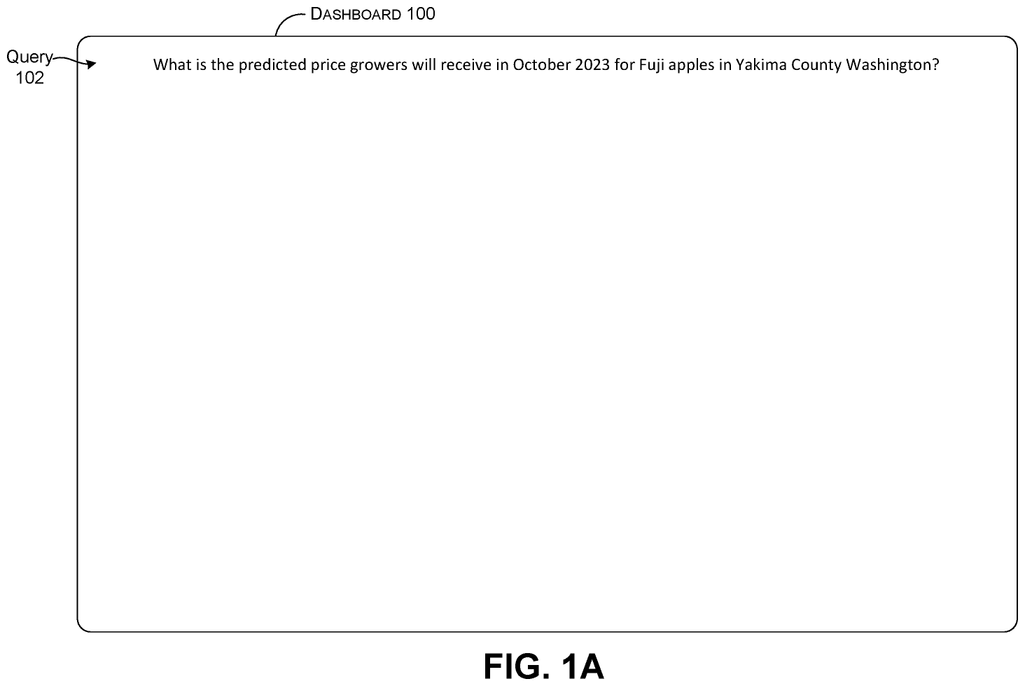

FIGS. 1A and 1B collectively show an example user interface in the form of a dashboard 100, which can implement the present concepts. FIG. 1A shows an example query 102 presented by the user in the dashboard. Continuing with the food supply chain system discussion above, in this example, the query is “What is the predicted price growers will receive in October 2023 for Fuji apples in Yakima County Washington.”

FIG. 1B shows example results 104 surfaced on the dashboard 100. The results 104 include a price graph 106 and events 108 organized into global, regional, and local event categories 110. The price graph 106 is separated into historical values 112 on the left and future predictions 114 based upon scenarios A, B, and C on the right by a demarcation of the present time (e.g., the time of the query). The predictions 114 are based upon the historical values 112 and effects of events 108 that affect the historical values. Note that the predictions 114 are shown in graphical form on the price graph 106 and in a detailed natural language form with confidences at the bottom of the results 104.

The first event category 110 relates to global impact and includes events in the form of global precipitation, global temperatures, and war in Ukraine. The second event category 110 relates to regional events and includes taxes in China and European regulations. The third event category 110 relates to worker availability to assist with apple harvest and processing (in Yakima County), local temperature (in Yakima County) and local precipitation (in Yakima County). Each of these events has been identified by expert sources as potentially having a significant impact on apple prices.

In this implementation, the dashboard 100 also provides the option for the user to adjust the weight assigned to each event 108. For instance, if the user/grower relies on a reservoir for irrigation water that is already low, the user may weight local precipitation higher. If the user changes any event weights, then the (future) predictions 114 (and or their probabilities) may change. In this example, the three highest ranking predictions (e.g., scenarios A, B, and C) are surfaced. The predictions rank from $52 to $45 per box for Fuji apples. The predicted prices can represent relative abundance or scarcity. The user can utilize this information to adjust his/her operations to produce more Fuji apples if the predicted price is high (e.g., predicted scarcity) or emphasize other crops if the predicted prices are low and indicate a glut. Both scarcity and gluts can be deleterious to food stability and ultimately to at-risk consumers. Thus, the present concepts provide accurate predictions that can allow entities, such as growers, to make educated decisions that stabilize the food supply and hence decrease potential shortages and famine.

Note that in this example, the user interface is a graphical user interface in the form of a dashboard. In other implementations, the user interface may take other form factors. For instance, the user interface may be audio based. Further, in this example, the user receives predictions by entering a query, such as a natural language query. The responsive predictions can be presented in various forms, such as graphically (e.g., illustrated on graphs), formulaically, and/or in natural language form (e.g., as a natural language answer to the natural language query), among others.

### Methodology

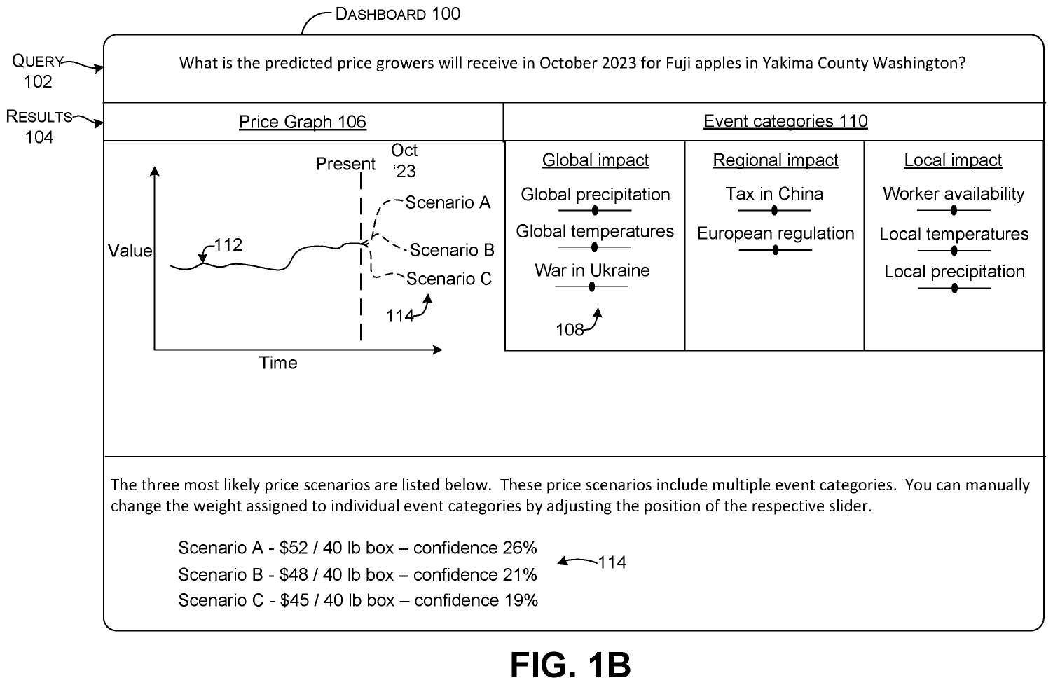

FIG. 2 shows a system 200 that can generate the dashboard 100 of FIGS. 1A and 1B. Time series input 202 (e.g., temporal data) and complex events input 204 (e.g., expert knowledge) can be correlated at 206. The time-series input 202 can include the historical values 112 of FIG. 1B. The complex events input 204 can include the complex events 108 of FIG. 1B. The correlated time-series input and complex events input 206 can be utilized to accomplish hybrid learning 208 and future prediction 210. Future prediction 210 (e.g., future value predictions), such as the event-based supply chain state prediction problem, can be formulated as multi-step time-series forecasting problems. Given an instant in time, some implementations can operate on the assumption that the supply chain states and event information that happened in the past are fully accessible. This allows training models based upon the past values and events.

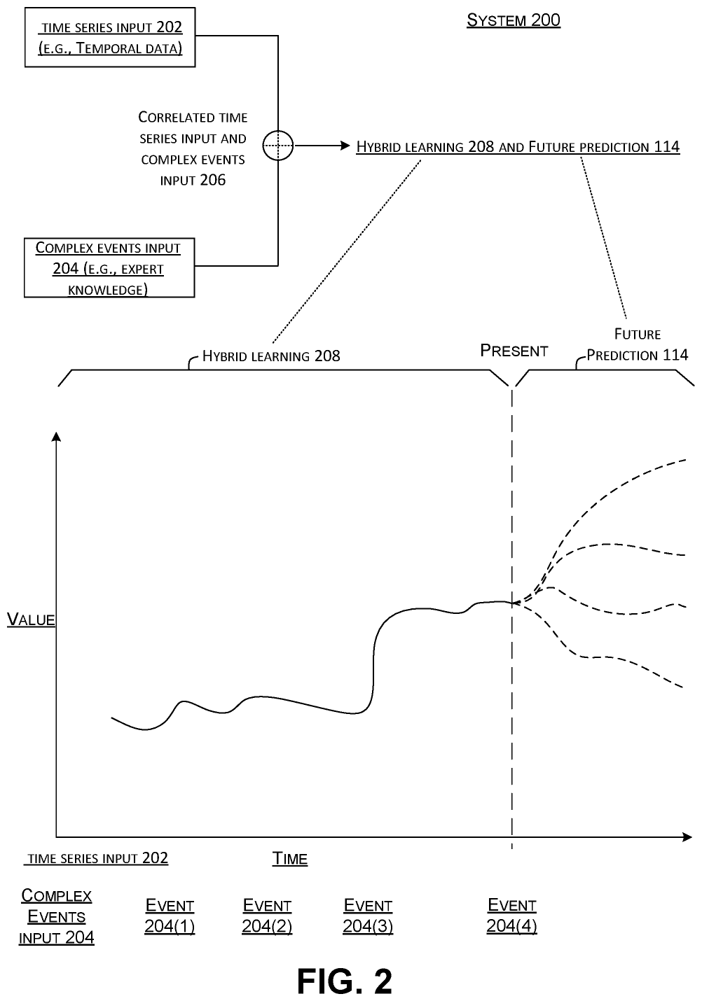

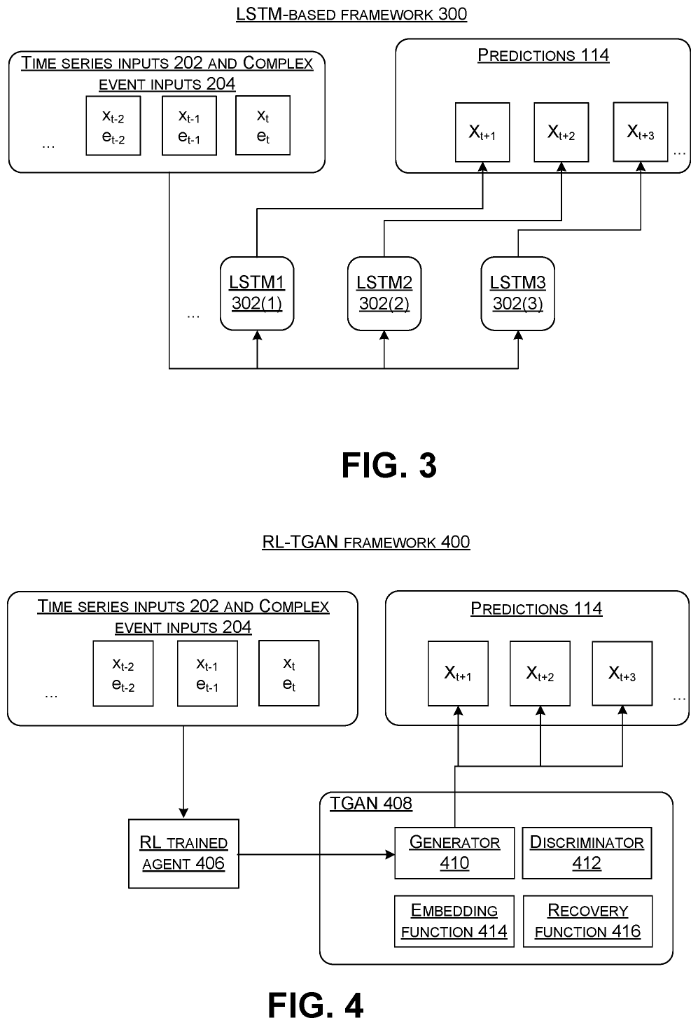

The present discussion includes details about creation and experimentation with two predictive models that are described relative to FIGS. 3 and 4. The two predictive models take the previous states and event information as input and output the future states of the supply chain system. Some of the main challenges of this problem come from the complexity of the input space. The encoded information can be sparse and very noisy because the complex event input 204 is high dimensional. This can occur because the event inputs might have direct, implicit, or even no correlation to the changes in future supply chain states. The explanation first turns to experiments with a baseline method that uses an LSTM-based multi-model illustrated in FIG. 3. The explanation then turns to a second method that involves a novel framework that combines generative networks, such as generative adversarial networks and a temporal sequential encoder, such as reinforcement learning illustrated in FIG. 4. The following sections describe the design details for both methods.

### Training Data Generation

The time-series input 202 can be obtained from many online sources. For example, many government websites track items of interest. Similarly, commodity trading exchanges track various commodities of intererst. Event information can be acquired from various sources. Some implementations can directly acquire event information (e.g., complex events input 204) from an autoregressive language model. However, the implementations described below instead simulate complex event inputs 204 by scraping news information directly from event portals, such as the Wikipedia current event portal for the sake of simplicity.

### LSTM-Based Multi-Model Prediction

FIG. 3 shows a multi-model long short-term memory (LSTM) framework 300 that provides a baseline for comparison. This method uses n=T LSTM models 302 to make a T step prediction 114, where each LSTM model 302 takes the whole input features as input and predicts the value for a fixed forward time step. This method has been proven to be effective and has been widely used in multi-step time-series prediction.

### RL-TGAN Prediction

FIG. 4 shows a reinforcement learning-time-series generative adverserial network (RL-TGAN) framework 400. The RL-TGAN framework 400 can handle the high dimension, noisy, and information sparsity challenges of the input space. RL-TGAN framework 400 utilizes time-series inputs 202 (e.g., historical values 112 of FIG. 1B) and complex event inputs 204 (e.g., complex events 108 of FIG. 1B). RL-TGAN framework 400 includes RL trained agent 406 and TGAN 408. The TGAN 408 includes a sequence generator 410, a sequence discriminator 412, an embedding function 414, and a recovery function 416. TGAN 408 generates predictions 114.

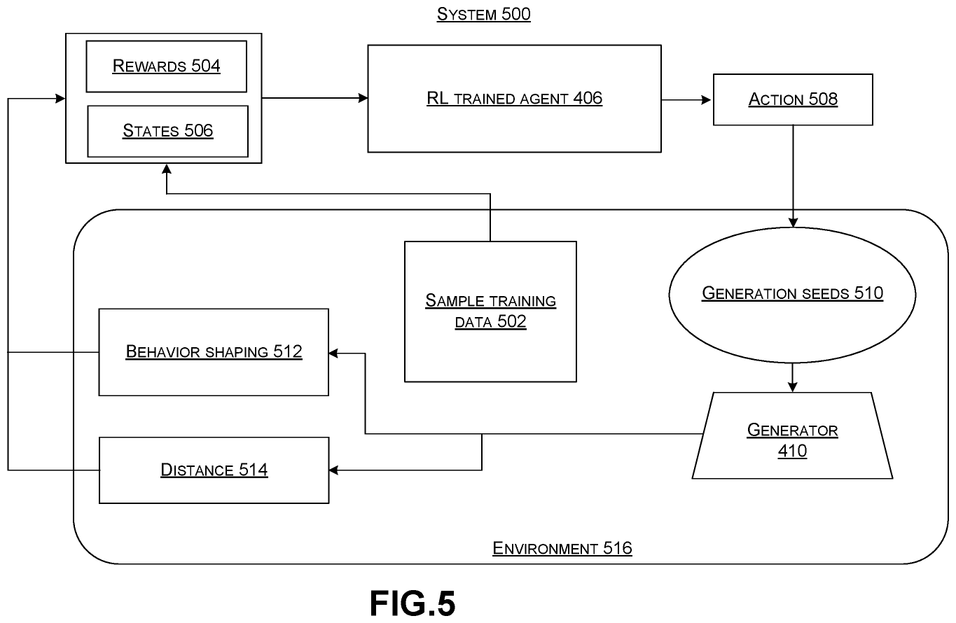

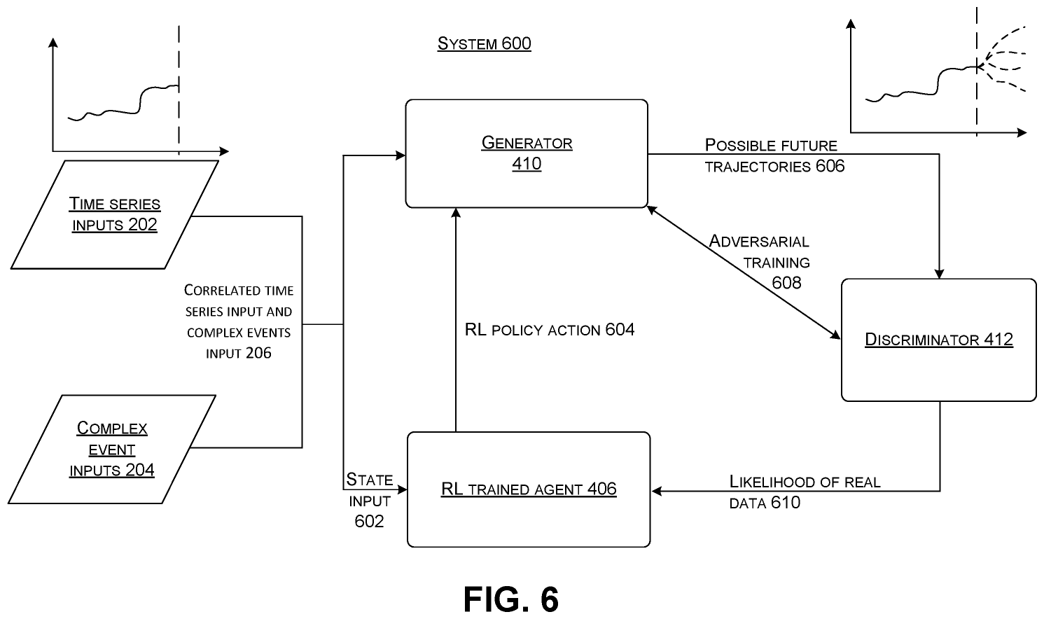

The RL-TGAN framework 400 of FIG. 4 can be more effectively described collectively with FIGS. 5 and 6, which are now introduced. FIGS. 5 and 6 convey similar concepts but from slightly different perspectives. FIG. 5 can be viewed as data-centric architecture. FIG. 6 can be viewed as a model-centric architecture.

FIG. 5 shows a system 500 that includes sample training data 502, rewards 504, states 506, RL trained agent 406, action 508, generation seeds (e.g., seeds) 510, generator 410, behavior shaping 512, and distance 514. The sample training data 502, generation seeds 510, generator 410, behavior shaping 512, and distance 514 can be viewed as existing in an environment 516.

The sample training data 502 is the time-series inputs 202 and the complex events inputs 204 combined together (e.g., the training data is past events and complex events that have already happened so the outcome is known). The training data 502 is used to build rewards 504 and states 506. The states 506 and rewards 504 are passed against the RL trained agent 406. The RL trained agent 406 produces the action 508. The action 508 identifies how close the time-series inputs 202 and the complex events inputs 204 are (e.g., what is the relationship between the time-series inputs 202 and the complex events inputs 204). The action 508 becomes the generation seeds (e.g., seeds for future generation) 510. Generation seeds can be viewed as a variable that represents the relationship between the events and the time-series inputs. The generation seeds 510 are fed to the generator 410. The generator 410 outputs predictions (114, FIG. 4). Note that at this point, the predictions are about something that has already occurred (e.g., is known). The predictions can be adjusted with behavior shaping 512 and distance 514 adjustments to accurately align with what actually happened (e.g., decrease the delta between what was predicted to happen and what actually happened). Behavior shaping 512 and distance 514 can be fed back into the rewards 504 and states 506. This process can be iteratively repeated so that the predictions approach what actually occurred (e.g., the generated model is being trained iteratively and becomes more and more accurate). Stated another way, the model can be iteratively trained to refine the model so that model's predictions approach (and/or equal) what actually occurred.

FIG. 6 shows a system 600 that includes many of the aspects introduced in FIGS. 4 and 5. In this case, the correlated time-series input and complex events input 206 (e.g., latent embedding input) from the time-series inputs 202 and the complex events inputs 204 is fed to the RL trained agent 406 and the generator 410. The RL trained agent uses the correlated time-series input and complex events input 206 as state input 602 and outputs the RL policy action at 604. The RL policy action 604 provides generative model tuning for the generator 410. The generator 410 produces possible future trajectories at 606 based upon the correlated time-series input and complex events input 206 and the tuning provided by the RL policy action 604. The discriminator 412 receives the possible future trajectories 606 and enhances the accuracy of the generator via adversarial training at 608. The discriminator 412 also provides feedback to the RL trained agent 406 by evaluating the likelihood of the real data 610 (e.g., what is the likelihood that individual possible future trajectories 606 represent what actually happens).

Looking collectively at FIGS. 4-6, the RL-TGAN framework 400 first uses adversarial training (608, FIG. 6) to learn a generator 410 (e.g., generator model) that models the temporal dynamics of the time-series inputs 202 and the complex events input 204 from a system of interest. As mentioned above, in this example the system of interest is a supply chain system. This ensures the outputs of this learned generative model have the same temporal characteristics as the historical data from the system of interest. The RL trained agent 406 (e.g., reinforcement learning trained policy) is then used to control the generator's output by manipulating the generation seeds 510.

### Learning the Temporal Transition Dynamic.

TGAN was chosen to learn the temporal dynamic in the historic data (e.g., the time-series inputs 202 and the complex events inputs 204). As introduced above, TGAN 408 consists of four network components including sequence generator 410, sequence discriminator 412, embedding function 414, and recovery function 416. Auto-encoding components (e.g., embedding function 414 and recovery function 416) are trained jointly with the adversarial components (e.g., sequence generator 410 and sequence discriminator 412), such that TGAN 408 simultaneously learns to encode features, generate representations, and iterate across time. For instance, let [symbol] and X be the vector space of static and temporal features. Then S∈ [symbol] , X∈X are random vectors that can be instantiated with specific values denoted s and x. TGAN 408 solves a global objective (i.e., objective.1) and a series of local step-wise objectives (i.e., objective.2):

$${min}_{\hat{p}} D ( p ( S , {X}_{1 : T} ) ‖ \hat{p} ( S , {X}_{1 : T} ) ) \qquad ( 1 )$$

$${min}_{\hat{p}} D ( p ( {X}_{t} \vert S , {X}_{t - 1} ) ‖ \hat{p} ( {X}_{t} \vert S , {X}_{1 , 1 : t - 1} ) ) \qquad ( 2 )$$

Where T is the length of a given data sequence, and D is some appropriate measure of distance between distributions.

Embedding function 414 is used to map the features space to a latent space, allowing the adversarial network to learn the underlying temporal dynamics of the data through lower-dimensional representations. Recovery function 416 is trained to reverse the embedding transfer. For instance, let [symbol] _{∫} and [symbol] _{X} be the latent vectors spaces of feature spaces S and X. The embedding function 414 represented as e:S×Πₜ X→ [symbol] ×Πₜ [symbol] _{X} consists of two recurrent networks that transfer static and temporal features to their latent codes [symbol] =e_{S}(s), hₜ=e_{X}( [symbol] , hₜ₋₁, xₜ). Similarly, the recovery function 416 consist of two feedforward networks that operate in the opposition direction and convert latent codes back to the original feature spaces represented as \tilde{s}= [symbol] (hₛ), \tilde{x}ₜ=r_{X}(hₜ).

Instead of producing synthetic output directly in the high dimensional feature space, the generator 410 outputs into the embedding spaces [symbol] , [symbol] _{X}. The generator models are two recurrent networks [symbol] = [symbol] ( [symbol] ), and ĥₜ=g_{X}( [symbol] , ĥₜ₋₁, zₜ) that take generation seed vectors Zₓ and [symbol] as input. The generation seed vectors are randomly sampled during the adversarial training to create various synthetic outputs. The discriminator 412 entails two bidirectional recurrent networks. Each bidirectional recurrent network has a feed forward output layer: [symbol] = [symbol] ( [symbol] ), \tilde{y}ₜ=d_{X}( [symbol] ₜ, \vec{u}ₜ), where [symbol] = [symbol] ( [symbol] , \tilde{h}ₜ, [symbol] ) and \vec{u}ₜ=\vec{c}ₓ( [symbol] , \tilde{h}ₜ, \vec{u}ₜ₊₁) are the sequences of backward and forward hidden states, [symbol] ₓ, \vec{c}ₓ are recurrent functions, and [symbol] , d_{X} are output layer classification functions.

Supervised loss learning temporal dynamic from the data with traditional generative adverserial network (GAN) training is challenging. Because the discriminator's binary adversarial feedback does not provide enough incentive for the generator to capture the step-wise conditional distributions in the data. In addition to the discriminator feedback, TGAN 408 uses a supervised loss function that assists the generator 410 to focus on the step-wise temporal relationship in the training data. In an alternating manner, the generator 410 also receives sequences of embedded actual data h_{1:t-1} to generate the next latent vector hₜ. Gradients can then be computed on a loss that captures the discrepancy between the real and generated data, [symbol] = [symbol] _{s,x1}_{_{1:T}}_{˜p}[Σₜ∥hₜ−gX( [symbol] , hₜ₋₁, zₜ)∥₂], where gX( [symbol] , hₜ₋₁, zₜ) is the approximated gradient with sample zₜ in stochastic gradient descent.

These components can be connected into a working pipeline. The embedding function 414 provides a latent space for information abstraction. The adversarial network (represented as adverserial training 608 on FIG. 6) operates within this space, and the latent dynamics of both real and synthetic data are synchronized through a supervised loss.

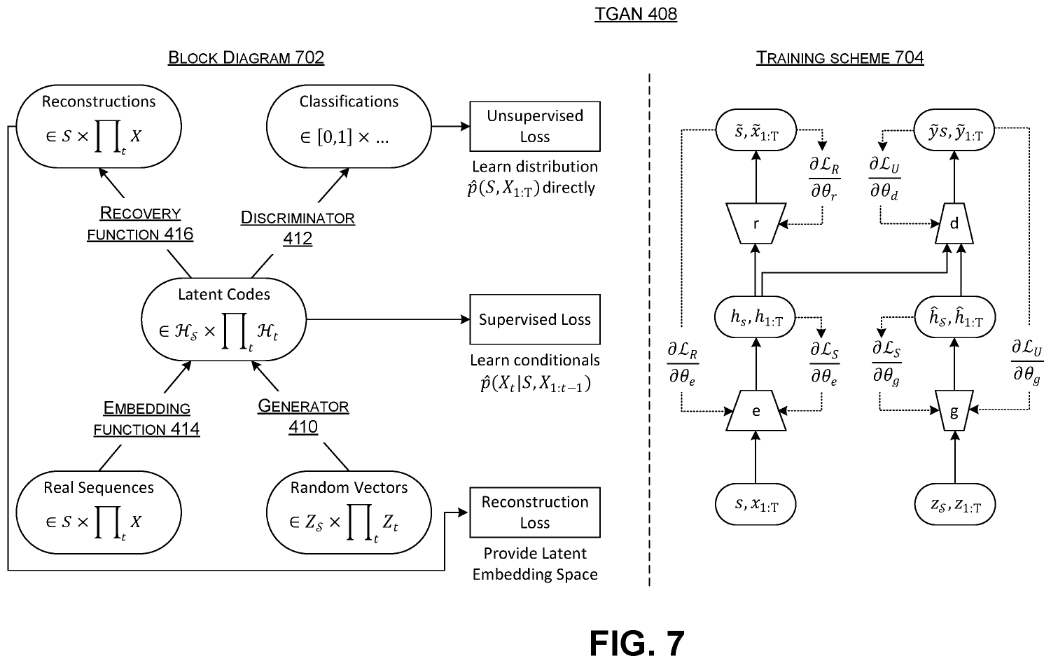

FIG. 7 shows these aspects in a formulaic manner that includes a block diagram 702 and a training scheme 704. The block diagram 702 shows component functions and objectives relating to the generator 410, discriminator 412, embedding function 414, and recovery function 416. Training scheme 704 employs solid lines to indicate forward propogation of data and dashed lines to indicate back propogation of gradients.

### Generate Possible Futures From Noisy Observation

Although the pre-trained generator 410 resulting from the TGAN training generates time-series data that follows the step-wise temporal dynamic in the real supply chain data, the outputs depend on the generation seed vectors Z_{X} and [symbol] . In order to properly predict the future data sequence given the history, Z_{X} and [symbol] need to be properly defined based on the historic data.

The description now returns to FIG. 5 which shows how some of the present implementations use the RL framework (e.g., RL trained agent) to solve this problem of generation seed vectors selection. FIG. 5 includes environment 516, which includes behavior shaping 512, distance 514, sample training data 502, generation seeds 510, and generator 410. The environment 516 also interacts with rewards 504, states 506, RL trained agent 406, and actions 508. In this case, the environment 516 is the combination of the TGAN generator g_{X}, recover function e_{X}, training dataset, and the discrepancy between the training data and the predicted data. The observed state sₜ is the supply chain time-series values and event information. During the training, sₜ is randomly drawn from the training dataset. The RL trained agent 406 takes an action aₜ to pick the correct generation seed Z_{X} and [symbol] for the generator 410. The synthesized embedded codes are then passed through the recovery function (416, FIG. 4) to obtain the predictions 114 (e.g., predicted future values) of FIG. 4.

In a typical reinforcement learning process, RL trained agent 406 obtains rewards by interacting with the environment 516. In this problem, a good generation seed selection should result in a more accurate predicted future. The rewards 504 for each action is given by the weighted sum of four loss functions: 1. loss in the original feature space S, X (r_{FS}=−L_{FS}). 2. loss in the embedding spaces [symbol] _{∫}, [symbol] _{X} (r_{E}=−L_{E}) 3. loss from the TGAN discriminators [symbol] and d_{X} (r_{D}=−L_{D}). 4. behavior shaping reward r_{B}. The final reward function is:

$$r = {w}_{FS} * {r}_{FS} + {w}_{E} * {r}_{E} + {w}_{D} * {r}_{D} + {w}_{B} * {r}_{B}$$

Where w_{FS}, w_{E}, W_{D}, and w_{B} are the corresponding weights for each of the reward terms.

This implementation uses an actor-critic reinforcement learning framework (e.g., via RL trained agent 406) to create agent policy that optimizes the reward function above. A parameterized actor network μ(s|θ^{μ}) maps the embedded observations [symbol] , hₜ to [symbol] , Z_{X} in a deterministic manner. A critic network Q(s, a) uses the Bellman equation and provides a measure of the quality of action and the state. The actor network is updated by policy gradient method:

$${∇}_{{θ}^{μ}} J ( θ ) = {𝔼}_{{s}_{t} \sim {ρ}^{β}} [ {∇}_{α} Q ( s , a \vert {θ}^{Q} ) {\vert}_{s = {s}_{t} , a = μ ( {s}_{t} )} {∇}_{{θ}_{μ}} μ ( s \vert {θ}^{μ} ) {\vert}_{s = {s}_{t}} ] \qquad ( 3 )$$

### EXPERIMENTS

Example results relate to the U.S. monthly apple price dataset from the USDA's National Agricultural Statistics Service (NASS) to evaluate the performance and demonstrate the characteristics of the proposed methods. In this case, 65% of the dataset was used for model training, and the rest was used for model testing. In this problem, the feature space of each time step Xₜ=(pₜ, eₜ), is the combination of the monthly apple price pₜ and embedded event data of the month eₜ. Since this investigation is interested in predicting the future apple prices but not the future events, the models will output p_{t+1:T} instead of the full feature space X_{t+1:T}. Note that this prediction problem does not contain static features so the technique can drop the [symbol] term from this section. The prediction horizon T is set to 3, such that given an instant of time t, the models take the full feature data from the past three months X_{t:t-2} as the inputs and predicts the apple prices for the following three months p_{t+1:t+3}.

### Prediction Accuracy

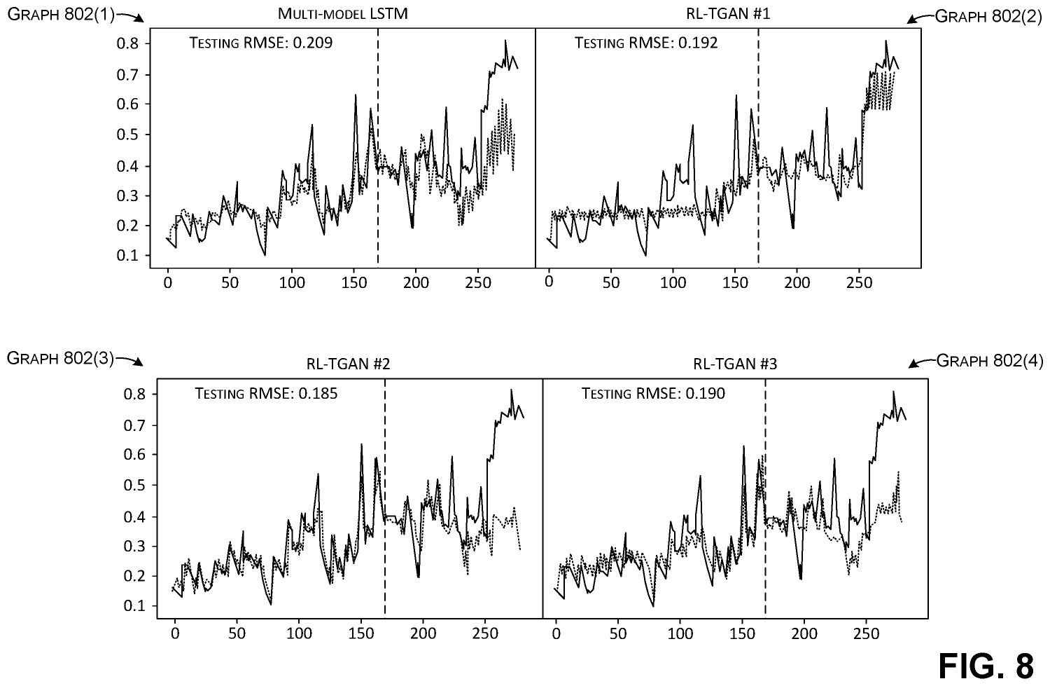

FIG. 8 shows four graphs 802(1)-802(4). Graph 802(1) conveys the multi-model LSTM results. Graph 802(2) conveys the RL-TGAN model #1 results. Graph 802(3) conveys the RL-TGAN model #2 results. Graph 802(4) conveys the RL-TGAN model #3 results. In each case, a vertical dashed line separates the dataset into training set on the left of line and testing set on the right of the line. On each graph 802, the solid lines (e.g., plots) show the ground truth values and the dotted lines (e.g., plots) show the predicted values.

After running a hyper-parameter search, the testing obtained a set of well performing models for each of the methods. FIG. 8 compares the best performing multi-model LSTM models of graph 802(1) with the top three best performing RL-TGAN models shown in graphs 802(2)-802(4), respectively. In terms of prediction accuracy on the testing data, all three of the RL-TGAN models with root mean square errors (RMSE) of 0.192, 0.185 and 0.190 respectively, outperformed the best performing LSTM model with RMSE of 0.209. Moreover, the testing indicates different hyperparameters could result in RL agents that are good at accomplishing different sub-tasks. For example the RL-TGAN model #1 could predict big sudden changes that are potentially caused by public health and weather related events. On the other hand, the RL-TGAN model #2 was able to reconstruct a lot of the local fluctuation details in its prediction.

### Sobol's Sensitivity Analysis

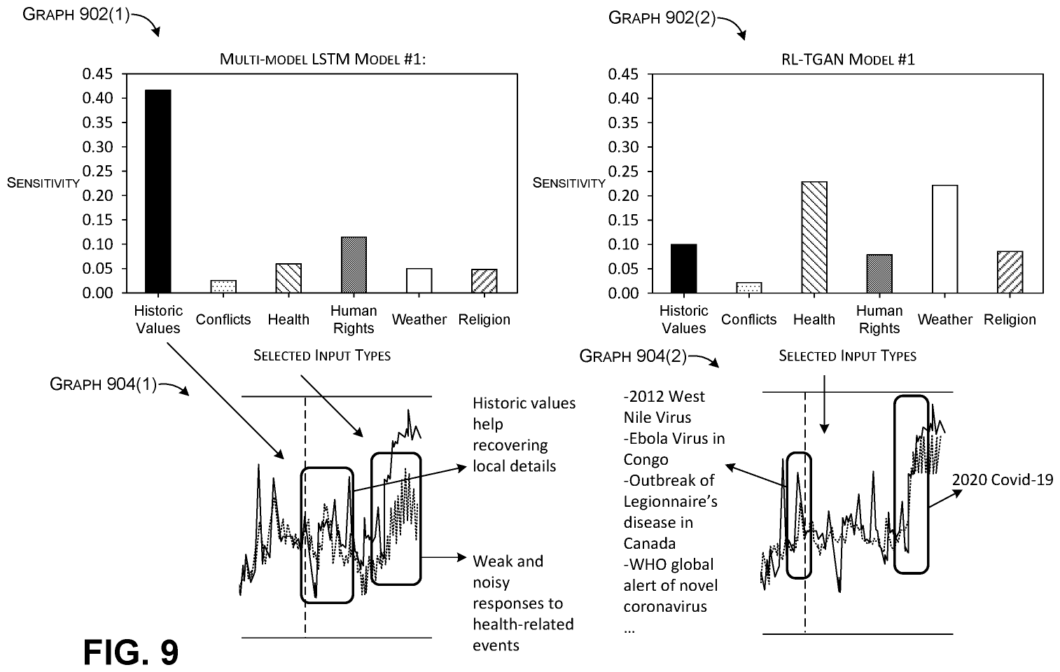

FIG. 9 shows a Sobol's sensitivity analysis on multi-model LSTM #1 RL-TGAN model #2. Bar plot graphs 902 demonstrate the model's output sensitivity to various input features. The lower graphs 904 demonstrate how the input sensitivity's differences effect different model's predictions.

The behavioral differences of the RL-TGAN models described above in the Prediction Accuracy Section is a very interesting observation. It shows that the RL-TGAN method could encourage the model to make predictions by better reasoning event information. By performing a Sobol's sensitivity analysis, the analysis indicates that the LSTM model predicts future apple prices mainly based-on historical apple prices as indicated in FIG. 9. In contrast, RL-TGAN model #1's prediction not only relies on the historic pricing data, but also relies heavily on public health and weather related events. The analysis indicates that in the training set, there is a time interval in 2012 that has multiple public health related news items and has a spike in apple prices shortly after that interval. During this time interval in 2012, there were multiple virus and disease outbreaks, and the world health organization (WHO) announced a global alert on a novel coronavirus case found in Qatar. The increased capability on reasoning event information allows that RL-TGAM model #1 to also successfully predict the drastic pricing increase caused by COVID-19 in 2020.

### Generating Possible Futures With Perturbations

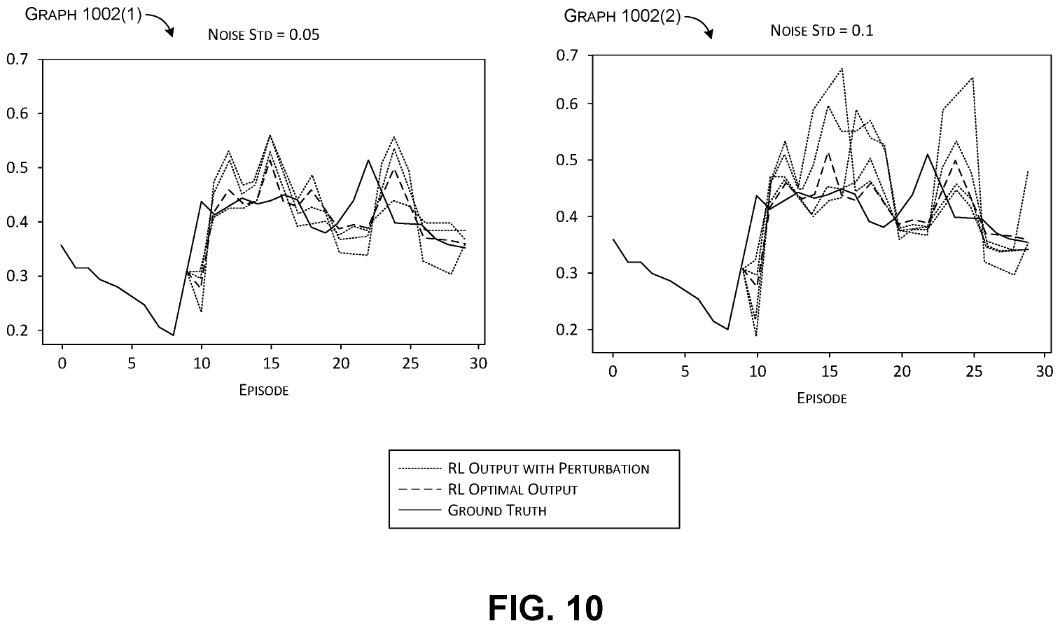

Another possible usage of the proposed RL-TGAN models is to provide multiple possible predictions by taking unpredictable future uncertainty into consideration. While the predictive model outputs an expected futures trajectory of the target system at a given time t, there could be unexpected events that happen after time t and influence the system. Some implementations could simply introduce random noises to the predicted trajectory to simulate these uncertainties. However, these perturbed trajectories will no longer follow the correct temporal dynamics of the system. In contrast, techniques can be employed to introduce small perturbations on generation seeds selected by the RL-agent, instead of directly perturb the predicted trajectory. The TGAN model will enforce the temporal dynamics of the final trajectory. This will cause the perturbed trajectory to be conditioned to both the original prediction and historical system dynamics. FIG. 10 demonstrates the alternative futures predictions by an RL-GAN model.

FIG. 10 shows two graphs 1002(1) and 1002(2) that convey alternative future predictions under two levels of perturbation. The first or left graph 1002(1) shows results with a noise standard deviation of 0.05. The second or right graph 1002(2) shows results for the same TGAN model with a noise standard deviation of 0.1.

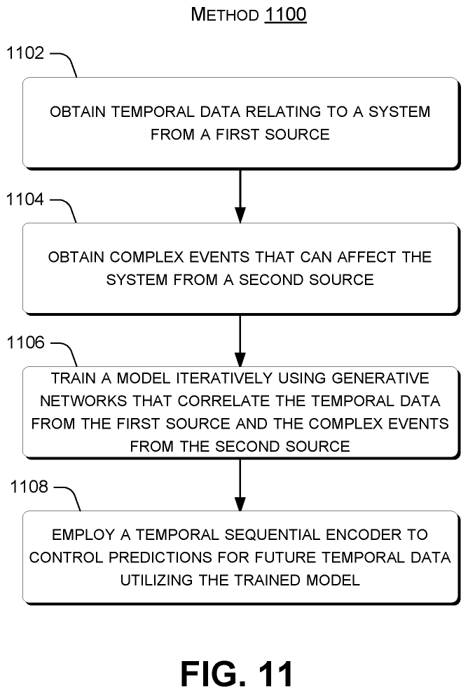

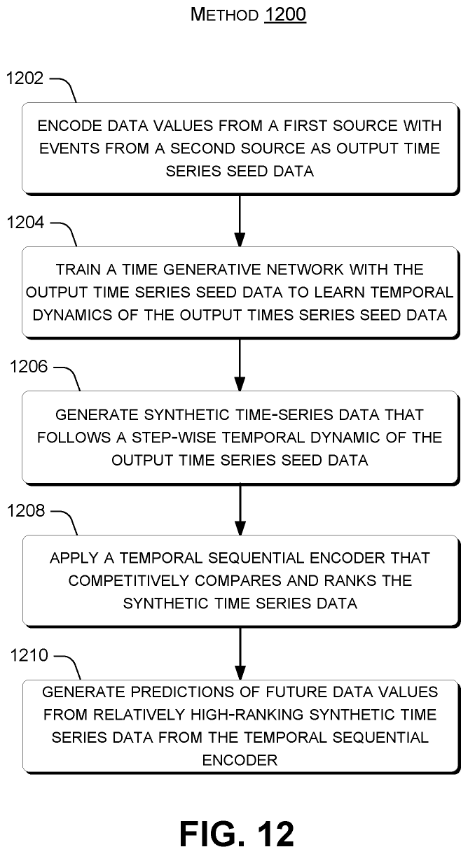

Several implementations are described in detail above. FIGS. 11 and 12 show flowcharts of two additional example methods.

FIG. 11 relates to method 1100. At block 1102, the method can obtain temporal data relating to a system from a first source.

At block 1104, the method can obtain complex events that can affect the system from a second source. The complex events can be obtained from various sources, such as event portals, examples of which are described above. The complex events can also be obtained from and/or used to populate a knowledge graph.

At block 1106, the method can train a model iteratively using generative networks that correlate the temporal data from the first source and the complex events from the second source. In some implementations, the model training entails training generative adversarial networks. In other implementations, the model training can entail training time-based generative adversarial networks or seed based generative decoders.

At block 1108, the method can employ a temporal sequential encoder to control predictions for future temporal data utilizing the trained model. In some implementations, the employed temporal sequential encoder can entail a reinforcement learning agent. In other implementations, the temporal sequential encoder can entail diffusion encoders, time-series-based encoders, transformer encoders, etc.

FIG. 12 relates to method 1200. At block 1202, the method can encode data values from a first source with events from a second source as output time-series seed data.

At block 1204, the method can train a time generative network with the output time-series seed data to learn temporal dynamics of the output time-series seed data. In some cases, training a time generative network entails training a time generative adversarial network. In other cases, training a time generative network entails a seed based generative decoder, such as variational auto encoders, transformer decoders, etc.

At block 1206, the method can generate synthetic time-series data that follows a step-wise temporal dynamic of the output time-series seed data.

At block 1208, the method can apply a temporal sequential encoder that competitively compares and ranks the synthetic time-series data. In some cases, applying a temporal sequential encoder comprises applying a reinforcement learning process. In other cases, applying a temporal sequential encoder entails applying diffusion encoders, time-series-based encoders, transformer encoders, etc.

At block 1210, the method can generate predictions of future data values from relatively high-ranking synthetic time-series data from the temporal sequential encoder.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

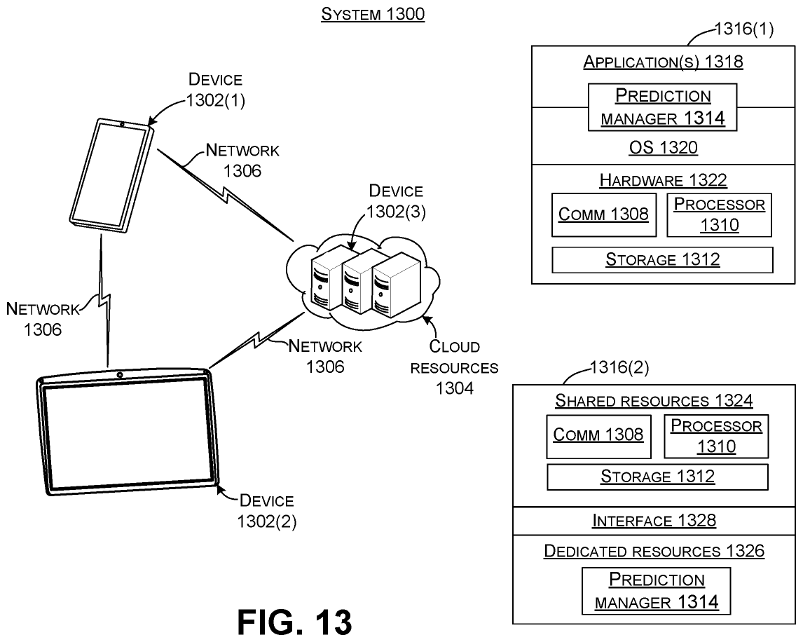

FIG. 13 shows an example system 1300. System 1300 can include computing devices 1302. In the illustrated configuration, computing device 1302(1) is manifest as a smartphone, computing device 1302(2) is manifest as a tablet type device, and computing device 1302(3) is manifest as a server type computing device, such as may be found in a datacenter as a cloud resource 1304. Computing devices 1302 can be coupled via one or more networks 1306 that are represented by lightning bolts.

Computing devices 1302 can include a communication component 1308, a processor 1310, storage resources (e.g., storage) 1312, and/or prediction manager 1314.

The prediction manager 1314 can manage the LSTM based framework 300 of FIG. 3 and/or the RL-TGAN framework 400 of FIG. 4. The prediction manager 1314 can also manage input and output of the frameworks 300 and/or 400, such as to generate the dashboard 100 of FIGS. 1A and 1B. The prediction manager 1314 may occur on the same computing device(s) as the LSTM based framework 300 and/or the RL-TGAN framework or the prediction manager 1314 may occur on a different computing device and communicate with LSTM based framework 300 and/or the RL-TGAN framework 400 over network 1306. For instance, the prediction manager 1314 could occur on computing device 1302(1) or 1302(2) while the LSTM based framework 300 and/or the RL-TGAN framework 400 could occur on other computing devices, such as computing device 1302(3) of the cloud resources 1304.

FIG. 13 shows two device configurations 1316 that can be employed by computing devices 1302. Individual computing devices 1302 can employ either of configurations 1316(1) or 1316(2), or an alternate configuration. (Due to space constraints on the drawing page, one instance of each configuration is illustrated). Briefly, device configuration 1316(1) represents an operating system (OS) centric configuration. Device configuration 1316(2) represents a system on a chip (SOC) configuration. Device configuration 1316(1) is organized into one or more applications 1318, operating system 1320, and hardware 1322. Device configuration 1316(2) is organized into shared resources 1324, dedicated resources 1326, and an interface 1328 therebetween.

In configuration 1316(1), the prediction manager 1314 can be manifest as part of the operating system 1320. Alternatively, the prediction manager 1314 can be manifest as part of the applications 1318 that operate in conjunction with the operating system 1320 and/or processor 1310. In configuration 1316(2), the prediction manager 1314 can be manifest as part of the processor 1310 or a dedicated resource 1326 that operates cooperatively with the processor 1310.

In some configurations, each of computing devices 1302 can have an instance of the prediction manager 1314. However, the functionalities that can be performed by the prediction manager 1314 may be the same or they may be different from one another when comparing computing devices. For instance, in some cases, each prediction manager 1314 can be robust and provide all of the functionality described above and below (e.g., a device-centric implementation).

In other cases, some devices can employ a less robust instance of the prediction manager 1314 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 1316(2) can be thought of as a system on a chip (SOC) type design. In such a case, functionality provided by the device can be integrated on a single SOC or multiple coupled SOCs. One or more processors 1310 can be configured to coordinate with shared resources 1324, such as storage 1312, etc., and/or one or more dedicated resources 1326, such as hardware blocks configured to perform certain specific functionality. Thus, the term “processor” as used herein can also refer to central processing units (CPUs), graphical processing units (GPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

Various examples are described above. Additional examples are described below. One example includes a method comprising encoding data values from a first source with events from a second source as output time-series seed data, training a time generative network with the output time-series seed data to learn temporal dynamics of the output times series seed data, generating synthetic time-series data that follows a step-wise temporal dynamic of the output time-series seed data, applying a temporal sequential encoder that competitively compares and ranks the synthetic time-series data; and generating predictions of future data values from relatively high-ranking synthetic time-series data from the temporal sequential encoder.

Another example can include any of the above and/or below examples where the training a time generative network comprises training a time generative adversarial network.

Another example can include any of the above and/or below examples where the applying a temporal sequential encoder comprises applying a reinforcement learning process.

Another example can include any of the above and/or below examples where the method further comprises presenting the generated predictions on a user interface.

Another example can include any of the above and/or below examples where the presenting is performed responsive to a query received from a user.

Another example can include any of the above and/or below examples where the presenting comprises a quantitative graph and/or a natural language answer to the query from the user.

Another example includes a computing system comprising a processor and a storage resource storing computer-readable instructions which, when executed by the processor, cause the processor to instantiate a generative network and a temporal sequential encoder, the generative network configured to model temporal transition dynamics of time-series data to associated complex events; and, the temporal sequential encoder configured to reason noisy observations associated with the model and to control generation of future predictions by the model.

Another example can include any of the above and/or below examples where the generative network comprises a time generative adversarial network or wherein the generative network comprises a seed based generative decoder.

Another example can include any of the above and/or below examples where the time generative adversarial network comprises a generator configured to produce possible future predictions of the time-series data and associated complex events.

Another example can include any of the above and/or below examples where the time generative adversarial network comprises a discriminator configured to receive the possible future predictions and enhance accuracy of the generator.

Another example can include any of the above and/or below examples where the discriminator is configured to enhance the accuracy via adversarial training.

Another example can include any of the above and/or below examples where the temporal sequential encoder comprises a reinforcement learning agent or wherein the temporal sequential encoder comprises diffusion encoders, time-series-based encoders, or transformer encoders.

Another example can include any of the above and/or below examples where the reinforcement learning agent is configured to receive rewards and states based upon the time-series data and the reinforcement learning agent is configured to produce an action that identifies how close the time-series data is to the associated complex events.

Another example can include any of the above and/or below examples where the reinforcement learning agent is configured to cause seeds to be generated from the action.

Another example can include any of the above and/or below examples where the seeds comprise a variable that represents a relationship between the time-series data and associated complex events.

Another example can include any of the above and/or below examples where the generative network is configured to iteratively refine the model with the seeds to enhance accuracy of the predictions.

Another example can include any of the above and/or below examples where the reinforcement learning agent is configured to control the generator's output by manipulating the seeds.

Another example can include any of the above and/or below examples where the generative network comprises an embedding function configured to provide a latent space for information abstraction that allows latent dynamics of both real and synthetic time-series data to be synchronized through a supervised loss.

Another example can include any of the above and/or below examples where behavior shaping and distance adjustments are applied to the model to decrease deltas between possible future predictions and actual values in the time-series data.

Another example includes a computing device comprising a hardware processor and a storage resource storing computer-readable instructions which, when executed by the processor, cause the processor to obtain temporal data relating to a system from a first source, obtain complex events that can affect the system from a second source, train a model iteratively using generative networks that correlate the temporal data from the first source and the complex events from the second source and employ a temporal sequential encoder to control predictions for future temporal data utilizing the trained model.

Another example can include any of the above and/or below examples where training a model comprises training the model using generative adversarial networks.

Another example can include any of the above and/or below examples where employing a temporal sequential encoder comprises employing a reinforcement learning agent.

Another example can include any of the above and/or below examples where the complex events are obtained from a knowledge graph.

### Conclusion

The description includes novel event-based future prediction frameworks that can use time-series generative adversarial networks to model the temporal transition dynamics of time-series data. An RL-agent is then trained to reason the noisy observations of the environment and to control the generator for future predictions. Different RL training settings can create RL agents that excel at different sub-tasks. Multiple possible futures can be generated by introducing perturbation to the generation seeds.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
encoding data values from a first source with events from a second source as output time-series seed data;
training a time generative network with the output time-series seed data to learn temporal dynamics of the output time-series seed data;
generating synthetic time-series data that follows a step-wise temporal dynamic of the output time-series seed data;
applying a temporal sequential encoder that competitively compares and ranks the synthetic time-series data; and,
generating predictions of future data values from relatively high-ranking synthetic time-series data from the temporal sequential encoder.

2. The method of claim 1, wherein training a time generative network comprises training a time generative adversarial network.

3. The method of claim 1, wherein applying a temporal sequential encoder comprises applying a reinforcement learning process.

4. The method of claim 1, further comprising presenting the generated predictions on a user interface.

5. The method of claim 4, wherein the presenting is performed responsive to a query received from a user.

6. The method of claim 5, wherein the presenting comprises a quantitative graph and/or a natural language answer to the query from the user.

7. A computing system comprising:
a processor; and
a storage resource storing computer-readable instructions which, when executed by the processor, cause the processor to instantiate a generative network and a temporal sequential encoder;
the generative network configured to model temporal transition dynamics of time-series data to associated complex events; and,
the temporal sequential encoder configured to reason noisy observations associated with the model and to control generation of future predictions by the model.

8. The computing system of claim 7, wherein the generative network comprises a time generative adversarial network or wherein the generative network comprises a seed based generative decoder.

9. The computing system of claim 8, wherein the time generative adversarial network comprises a generator configured to produce possible future predictions of the time-series data and associated complex events.

10. The computing system of claim 9, wherein the time generative adversarial network comprises a discriminator configured to receive the possible future predictions and enhance accuracy of the generator.

11. The computing system of claim 10, wherein the discriminator is configured to enhance the accuracy via adversarial training.

12. The computing system of claim 7, wherein the temporal sequential encoder comprises a reinforcement learning agent or wherein the temporal sequential encoder comprises diffusion encoders, time-series-based encoders, or transformer encoders.

13. The computing system of claim 12, wherein the reinforcement learning agent is configured to receive rewards and states based upon the time-series data and the reinforcement learning agent is configured to produce an action that identifies how close the time-series data is to the associated complex events.

14. The computing system of claim 13, wherein the reinforcement learning agent is configured to cause seeds to be generated from the action.

15. The computing system of claim 14, wherein the seeds comprise a variable that represents a relationship between the time-series data and associated complex events.

16. The computing system of claim 15, wherein the generative network is configured to iteratively refine the model with the seeds to enhance accuracy of the future predictions.

17. The computing system of claim 16, wherein the reinforcement learning agent is configured to control the generator's output by manipulating the seeds.

18. The computing system of claim 17, wherein the generative network comprises an embedding function configured to provide a latent space for information abstraction that allows latent dynamics of both real and synthetic time-series data to be synchronized through a supervised loss.

19. The computing system of claim 18, wherein behavior shaping and distance adjustments are applied to the model to decrease deltas between possible future predictions and actual values in the time-series data.

20. A computing device, comprising:
a processor; and
a storage resource storing computer-readable instructions which,
when executed by the processor, cause the processor to:
obtain temporal data relating to a system from a first source;
obtain complex events that can affect the system from a second source;
train a model iteratively using generative networks that correlate the temporal data from the first source and the complex events from the second source; and,
employ a temporal sequential encoder to control predictions for future temporal data utilizing the trained model.
